(19) United States
(12) Patent Application Publication
(10) Pub. No.: US 2007/0078959 A1
(43) Pub. Date: Apr. 5, 2007

(54) Low-power proxy for providing content listings in ad-hoc, peer to peer networks

(76) Inventor: Yinghua Ye, Stoneham, MA (US)

Correspondence Address: Hollingsworth & Funk, LLC, Suite 125, 8009 34th Avenue South, Minneapolis, MN, 55425, US

(21) Appl. No.: 11/242,102

(22) Filed: Oct. 3, 2005

(51) Int. Cl. G06F 15/173

(52) U.S. Cl. 709/223

(57) ABSTRACT

Providing access to content in an ad-hoc peer-to-peer network involves providing the content from at least one media server coupled to the network. Metadata associated with the content is sent from the media server to a proxy. The media server to enters a low-power state, and if the media server is in the low-power state, the proxy provides the metadata on behalf of the media server in response to content listing requests intended for the media server.

### FIELD OF THE INVENTION

This invention relates in general to computer networking, and more particularly to a system, apparatus and method for providing content listings in peer-to-peer networks.

### BACKGROUND OF THE INVENTION

The ubiquity of cellular phones has led to demands for more general purpose computing features in these devices. For example, programs such as personal information managers and email clients are particularly useful when combined with the always-at-ready, always-connected nature of cell phones. This has led to demand for phones that can connect to a variety of networks. For example, mobile devices may include features that allow interaction with other consumer electronics devices.

A standard known as Universal Plug and Play™ (UPnP) provides a way for disparate processing devices, including mobile devices, to exchange data over local networks. The UPnP standard defines an architecture for peer-to-peer network connectivity utilizing a wide variety of electronic devices. The UPnP standard includes standards for service discovery, and is mainly targeted for proximity or ad hoc networks.

The UPnP model is designed to support zero-configuration networking and automatic discovery for a wide variety of device categories. This allows a device to dynamically join a network, obtain an Internet Protocol (IP) address, convey its capabilities, and learn about the presence and capabilities of other devices. Many local network and Internet-based protocols such as Dynamic Host Configuration Protocol (DHCP) and Domain Name Service (DNS) may be included in a UPnP network. A device can leave a UPnP network smoothly and automatically without leaving any unwanted state behind.

Satisfactory mobile multimedia experience in the digital home relies on seamless content search, adaptation and delivery. There are two typical scenarios that a mobile device interacts with a UPnP or other home network: 1) the mobile device acts as a content server and serves content to a content renderer (TV, PC, etc) in the home network; 2) the mobile phone acts as a content destination and receives content from a content server (PC, STB, etc) in the home network. In both cases, the desired content must be located and delivered to the content destination. Numerous challenges arise in this content consumption cycle.

For example, when the mobile user in the second scenario transfers multimedia content from the home network to the mobile phone, the user typically does not care (or know) where the content is located. The UPnP standard has defined various mechanisms for discovering content on the home network. However, because the content may be distributed among a number of home media servers, the performance experienced by the user in discovering the content may be subject to the constraints of the slowest responding server. In particular, those media servers that are in a reduced power mode (e.g., a sleep mode) may take much longer to respond than active devices.

In order to improve the user experience in UPnP networks and related architectures, content search mechanisms should account for various power-saving states of the servers (such as inactive or sleep states) in order to increase response times while still retaining the power saving benefits provided by the states.

### SUMMARY OF THE INVENTION

To overcome limitations in the prior art described above, and to overcome other limitations that will become apparent upon reading and understanding the present specification, the present invention discloses a system, apparatus and method for providing a low power content metadata proxy in an ad-hoc peer-to-peer network. In accordance with one embodiment of the invention, a method involves providing the content from at least one media server coupled to the network. Metadata associated with the content is sent from the media server to a proxy. The media server enters a low-power state, and the metadata is provided from the proxy on behalf of the media server in response to content listing requests intended for the media server if the media server is in the low-power state.

In a more particular embodiment, the at least one media server comprises a plurality of media servers, and the method further involves aggregating metadata received from the plurality of media servers into a single database. The method may include forming a plurality of content databases each associated with one of the media servers, where each content database duplicates metadata available from the associated media server.

In another, more particular embodiment, the method further involves receiving the content listing requests intended for the plurality of media servers at the proxy regardless of whether the media servers are in the low power states. Further, the content listing requests may be forwarded to the intended media server for any of the media servers that are not in the low-power states. In one arrangement, the method further involves signaling the low-power state from the media server to the proxy in response to the media server beginning to enter the low-power state. In this arrangement, the method may further involve synchronizing the metadata between the proxy and the media server in response to the signaling and before the media server enters the low-power state.

In another, more particular embodiment, the method further involves receiving a request for content at the proxy server in response to the metadata provided from the proxy server on behalf of the media server, signaling to the media server to wake-up in response to the request, and providing the requested content from the media server.

In another embodiment of the invention, an apparatus includes a network interface capable of communicating via an ad-hoc peer-to-peer network. A processor is coupled to the network interface, and a memory is coupled to the processor. The memory includes a low power proxy having instructions that cause the processor to receive via the network interface metadata associated with content provided from at least one media server coupled to the network. The processor detects the media server entering a low-power state and receives via the network interface content listing requests intended for the media server from network entities. If the media server is detected to be in the low-power state, the instructions cause the processor provide the metadata to the network entities via the network interface on behalf of the media server in response to the content listing requests.

The apparatus may further include a database coupled to the processor and wherein the memory includes instructions causing the processor to store aggregated metadata received from a plurality of media servers in the database. In another arrangement, the apparatus further includes a plurality of content databases coupled to the processor. Each of the content databases is associated with one of the media servers, and the processor is further caused to place in each content database metadata available from the associated media server.

The apparatus may further include a signaling module that causes the processor to detect a signal via the network interface indicating the media server will enter the 6low-power state, and cause the apparatus to receive the metadata from the media server in response to the signal. The low power proxy may further cause the processor to receive the metadata from the media server before the media server enters the low-power state.

In another embodiment of the invention, a computer-readable medium has instructions which are executable by a data processing arrangement capable of being coupled to a network. The instructions are for performing steps that include receiving via the network metadata associated with content provided from at least one media server coupled to the network. The data processing arrangement detects the media server entering a low-power state and receives via the network interface content listing requests from network entities intended for the media server. If the media server is detected to be in the low-power state, the data processing arrangement provides the metadata to the network entities via the network interface on behalf of the media server in response to the content listing requests.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a logical diagram of a content distribution environment according to embodiments of the present invention;

FIG. 2 is a block diagram illustrating a low power proxy according to an embodiment of the present invention;

FIG. 3 is a block diagram illustrating a low power proxy according to an alternate embodiment of the present invention;

FIG. 4 is a sequence diagram illustrating an example of synchronizing and providing content data from a low power proxy according to embodiments of the invention;

FIG. 5A is a flowchart illustrating a procedure for providing access to content via a low power proxy according to embodiments of the invention;

FIG. 5B is a flowchart illustrating a more particular procedure for providing access to content via a low power proxy according to embodiments of the invention;

FIG. 6 is a block diagram illustrating an example computing structure suitable for providing content gateway and low power proxy functionality according to embodiments of the present invention; and

FIG. 7 is a block diagram illustrating a representative mobile computing arrangement capable of carrying out operations in accordance with embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention provides an efficient and user-friendly searching for content among multiple devices coupled via a network. In particular, systems, methods and apparatuses are described for a content search framework that provides the improved low power management for devices in the network. Thus, the invention provides, among other things, an improved framework that enables a user to locate and consume (e.g., view, hear, or otherwise perceive) content on a network, such as a Universal Plug-and-Play™ (UPnP) home network.

In a typical UPnP content query where multiple media servers exist, a user device sends search actions to media servers one by one, until the desired content is located. In one arrangement, these search queries can be accomplished by using a content gateway that acts as a central repository for viewing available content. Where a content gateway is used, the content gateway acts as virtual media server and media server control point, and the user sends search actions to the content gateway. The content gateway will forward the search action to every media server that it is aware of, and merges the results from all media servers. Even there is no content that user wants to query, the media server will respond.

The content gateway may also be configured to aggregate metadata for all of the content in a single, commonly accessible location. The aggregation may also be distributed, such that various server entities aggregate listings for a part of the network. Aggregating the content listings at one or more locations provides can reduce the need for system-wide queries, deal with redundancies, reduce query response times, centralize user profiles, and present a uniform view of data, and provide many other advantages.

Besides acting as a central repository for querying content, the content gateway or similar devices can be configured deal with low power states of the various content servers. Many devices may be required to enter low power states, e.g., to be compliant with standards (e.g., Energy Star) or to conserve battery power. It often takes an appreciable amount of time for a device to transition from a sleep state to an active state. This delay may be experienced by a user trying to view content listings, even if the user has no desire to view content on the sleeping server. This is because, as described above, a user device or content gateway may need to query each media server to satisfy each query. Besides causing delays, frequent, unnecessary wakeups may cause sleeping devices to consume more power than is strictly necessary. Therefore a low power proxy can be introduced into the system to selectively take over directory services for sleeping devices. The low power proxy can be included in a content gateway, or in some other network device. In addition to improving system responsiveness by taking over directory services for sleeping devices, the low power proxy helps to prolong the battery life of mobile servers while still allowing the content to be always available on the network.

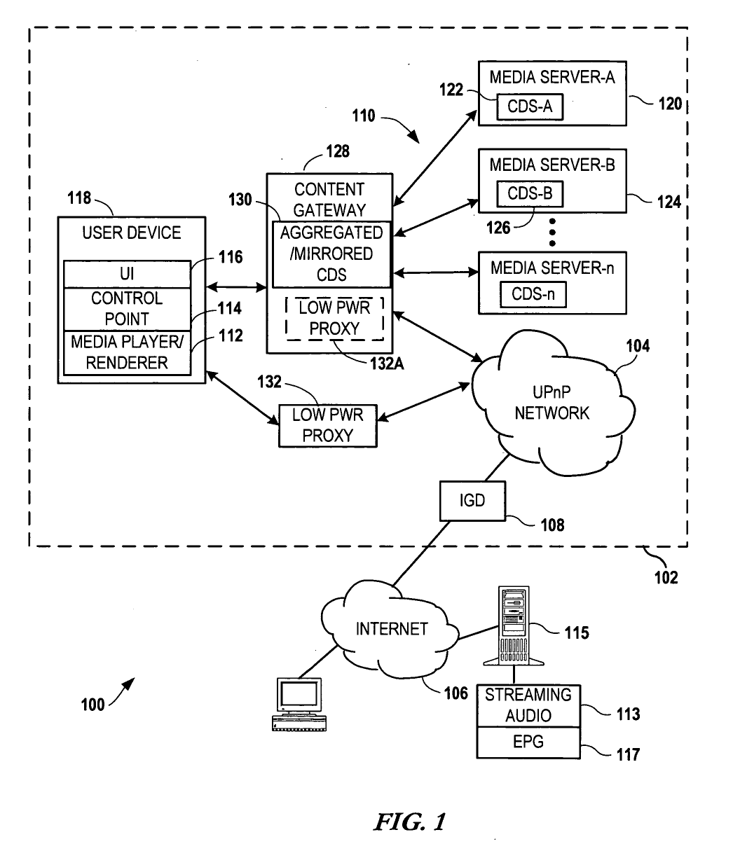

Turning now to FIG. 1, which shows a logical diagram of a content distribution system 100 according to embodiments of the present invention. Generally, the system 100 includes a local networking environment 102. The local networking environment 102 is generally a collection of network elements located within a defined physical space. The local networking environment 102 may include, for example, one or more segments of a UPnP network 104.

In order to facilitate an understanding of the invention, various aspects of the present invention may be described in the context of a UPnP networking environment. It will be appreciated, however, that the invention may be applicable in any system or application where ad-hoc data communications between devices such as consumer and mobile electronics is desired. For example, data transfer technologies such as X10, infrared data transfer, Ultra Wide Band (UWB), power line networking, zeroconf, Bluetooth, etc., may be with or instead of UPnP to provide some level of intercommunication in the local environment 102.

The local networking environment 102 may include any type of communication systems and networks, such as proximity and ad-hoc UPnP networks that are adapted for business and/or consumer use. The local networking environment 102 typically includes a home or office, although it will be appreciated that other environments may provide UPnP connectivity, including automobiles, airplanes, boats, public wireless hotspots, etc.

The UPnP network 104 is designed to facilitate simple and ubiquitous data transfer between a wide variety of devices. The UPnP framework includes a peer-to-peer Internet Protocol (IP) network environment that is independent of operating systems and architectures. A UPnP implementation may use various combinations of open Internet protocols, including HyperText transfer protocol (HTTP), eXtensible Markup Language (XML), Simple Object Access Protocol (SOAP), Simple Service Discovery Protocol (SSDP), and General Event Notification Architecture (GENA). Any data processing device can be UPnP-enabled, including PCs of all types, intelligent appliances, consumer electronics, and mobile/wireless devices.

Entities within the local environment 102 may have access to external networks such as the Internet 106. For example, a UPnP Internet Gateway Device (IGD) 108 may provide external network access to devices coupled to the UPnP network 104. The IGD 108 may include any network addressable device that resides at the edge of a UPnP network. The IGD 108 provides the UPnP network 104 with a WAN interface for accessing external networks such as the Internet 106. The IGD 108 may also provide local addressing and routing services between one or more LAN segments and to and from the Internet.

The UPnP standard is designed to provide communications between a wide variety of devices. One branch of the UPnP specification deals in particular with Audio Video (AV) devices and communications. The UPnP AV specification is an adaptation of UPnP that allows consumer electronics devices to distribute digital entertainment content throughout a home/office network. UPnP AV deals with three specific logical entities, media servers 110, media renderers 112, and control points 114. Media servers 110 may include any manner of data processing arrangement that provides content to user devices on the UPnP network 104.

Media servers 110 can access entertainment content and provide that content on demand in various formats. The content provided by the media servers 110 may be stored on the device, or may be stored elsewhere. As an example of the latter case, a streaming audio service 113 may be provided by a server 115 coupled to the Internet 106. One of the media servers 110 may be able to access that audio server 115 via the IGD 108 and provide the audio to a locally coupled rendering device 112. In order to provide the audio signal to the local device 112, the media server 110 may perform transcoding, handling of digital rights managements, and other manipulations of the content.

Another example of remote content that may be made accessible by the media servers 110 is an Electronic Program Guide (EPG) service 117. An EPG service may be provided by a server 115 coupled to the Internet 106. Generally, the EPG service 117 provides a listing of content available from a local and/or remote content provider. For example, a cable television provider may have an Internet-accessible EPG service 117 that describes the local cable TV programs playing on a given day. The EPG service 117 may be accessed by a dedicated control/rendering device (e.g., a set top box) and may also be accessed by a general-purpose control device, such as a computer or “smart” remote control. Although the EPG service 117 may be accessed directly by a control point 114 and or rendering device 112, the EPG service 117 may be useful to the UPnP network 104 if the EPG 117 is offered as a UPnP service by a media server 110.

Devices that act as media servers 110 may include music and video personal recorders (e.g., PVRs), home computers, digital playback devices (e.g., CD, DVD, DAT), network services (e.g., Internet radio), and similar devices. It will be appreciated, however, the media server 110 is a logical abstraction for use in UPnP AV networks, and any device capable of presenting data may be used as a media server 110.

The media renderers 112 are those devices that allow users to utilize and/or perceive data available on media servers 110. Typical media renderers include audio and video playback apparatus, although a media renderer 112 may perform any transformation and/or presentation of data that is useful to an end user. The interaction between the media servers 110 and media renderers 112 may be controlled by control points 114. Control points 114 typically provide a user interface 116 that can be manipulated by users to control aspects of data transfers on the UPnP network 104. Control points 114 can be used to select source and destinations for data, and may be used to control playback (e.g., pause, rewind), adjust playback (e.g., volume, brightness) and provide any other user-selectable function associated with data transactions.

It will be appreciated that the local networking environment 102 may support any number of media renderers 112 and control points 114. For purposes of illustration, a single end-user device 118 is shown that includes both the media renderer 112 and control point 114, as well as having a user interface 116. The user device 118 is adapted to access a plurality of media servers 110 via the UPnP network 104. In a typical UPnP network 104, the user device 118 may be able to directly access the media servers 110 in a peer-to-peer fashion. In particular, the user device 118 may be able to listen to and/or query the media servers 110 in order to discover content available on the servers 110. The task of enumerating content available on a UPnP media server 110 may be handled by a Content Directory Service (CDS) running on the server 110. For example, media servers 120, 124 may each include a respective CDS 122, 126 that allows devices to discover and use content stored on and/or accessible via the associated servers 120, 124.

The CDS allows the user device 118 (and other UPnP devices) to browse the content on the media servers 110 and obtain detailed information about individual content objects. The CDS is provided as a UPnP service template, identified as “urn:schemas-upnp-org:service:ContentDirectory: 1,” where the numeral “1” signifies the latest version. The CDS specification uses an object-oriented-classification of CDS accessible content. All CDS data items are derived from the “object” base class. The CDS specification also defines at least two first level classes that directly inherit from “object.” The first of these first-level classes is known as an “item.” Items may include individual pieces of content such as songs and video clips. The other first-level class defined in the CDS specification is the “container” class. Containers may be used to represent collections of items, such as a playlists and photo albums. Nearly any type of content can be accessed and controlled via CDS using item and container objects. Many specific and useful content objects that provided by the CDS may inherit from these two first-level classes (e.g., “audioltem”).

The CDS provides lookup functions such as “browse” and “search” that allows devices to discover individual data objects stored on the media servers 110. The CDS also provides functions that allow inserting/creating new objects in the media servers 110. Once data objects have been located in the CDS, metadata associated with the objects can be used for locating the content via a control point 114 and/or renderer 112. For example, the metadata may include a Universal Resource Identifier (URI) that points to a file located on the media server. By using a standard content lookup method (e.g., the CDS), the processes of storing, retrieving, changing, and rendering digital content can be handled by many UPnP devices. The standards-based nature of UPnP allows these devices to successfully communicate such actions, even though the devices may be from different vendors and use different operating systems.

It will be appreciated that modem users may have a variety of sources that act as media servers 110. For example, media servers may include Personal Video Recorders (PVR) that stores televisions shows, a personal computer that stores a variety of data, and an MP3 player that stores music and is enabled to share the-music over the UPnP network 104. One advantage of using UPnP media servers 110 is that the content stored in the media servers 110 can be accessed by a variety of devices in different locations throughout the local environment 102. Therefore, a user device 118 that is readily portable, such as a mobile phone or PDA, makes an ideal control point 114. In many cases, a portable user device 118 also makes an ideal rendering device 112.

In order for a portable user device 118 to access data from the media servers 110, the device 118 must communicate with a plurality of CDS (e.g., CDS 122, 126). It will be appreciated that each CDS may contain references to thousands of content objects. The bandwidth and processing power consumed in accessing the CDSes from a portable user device 118 may be quite large if the device 118 must query a large number of servers, enumerate a large number of objects, and identify and/or merge redundant objects. Moreover, the user may not know and does not care in what specific server the content is located. Yet the nature of the multiple CDSs may require doing an exhaustive search of all servers.

Large content collections contained on the media servers 110 may impact the ability to efficiently access CDS metadata associated with the content. In a conventional approach, the portable device 118 sends a separate search action to each of the media servers 110, and processes the results of these searches separately. In order to alleviate the inefficiencies of submitting separate content searches, a content gateway 128 may be used to provide a single access point for UPnP network content listings. In this way, the user device 118 point only needs to send a single search request to the content gateway 128. The content gateway 128 may include an aggregated/mirrored CDS 130 that contains some or all of the entries available from the media servers 110. The aggregated/mirrored CDS 130 may be used to more efficiently communicate content directory data between the user device 118 and the media servers 110. By using a single CDS 130 for all content application, the overhead and complexity involved in contacting multiple media servers 110 can be reduced.

An additional factor that may degrade access time experienced by the user device 118 is that some or all of the media servers 110 may implement some form of power management. One aspect of power management that can affect system performance is power-saving/sleep modes of servers 110 and other devices. Generally, a power-saving mode involves causing electrical components of the servers 110 to run at a reduced performance level in order to conserve electricity. Examples of power-saving mode actions include slowing down or stopping processors, stopping hard drive rotation, slowing down or stopping memory and I/O bus clocks, removing power from peripheral devices (e.g., monitors, expansion cards), etc.

The servers 110 generally have various mechanisms to come out of sleep/power-saving modes. The UPnP specification includes low-power management standards. The UPnP low-power management specification defines various device models that may depend on-the triggers that force devices to transition to different sleeping states. The device can be modeled as a sleep/autonomous device that can go to sleep autonomously by using timers, a sleep/controlled device that can go to sleep mode after receiving an external interaction, (e.g., a control message), a wake up/autonomous devices that wakes up autonomously using local timers, or a wake up/controlled devices that requires an external interaction, such as control message, to wake up.

UPnP low-power management features allows UPnP devices to implement power saving modes and conserve energy, yet still remain a member of the UPnP networks while in the power-saving modes. Power-saving modes are particularly important for mobile devices. Mobile devices are typically battery-powered, and implementation of power management can help mobile device operate longer, thus enhancing the experience for users of such devices.

Sleep capable UPnP devices may implement the following sleep modes: transparent, deep sleep/online, deep sleep/offline. When a device is in transparent sleep state, the underlying bearer enters power saving mode, but the device has full functions of required to interact via UPnP. Devices in deep sleep/online keep a partial UPnP state (e.g., discovery capability) and can be awakened by a power aware control point. For deep sleep/offline devices, a proxy is used to allow a device to go into deep sleep offline and still be able to be part of the UPnP network. The proxy handles the bearer dependent wake up mechanism (e.g., Wake on LAN or Wake on Wireless etc.).

Sleep modes may provide an acceptable trade off between device responsiveness and power efficiency for devices that users access directly. This is because the users can be given cues that the device is sleeping and will soon be waking up. For example, a user who tries accessing a desktop computer that is in sleep mode may hear noises of the drives winding up and see a splash screen in the monitor informing the user that the computer is waking up and will soon be operation. If the user understands that delays in immediate access to a device are due to a sleep mode, the user can take appropriate actions, including accepting the tradeoff of power consumption versus response, or disabling the power saving mode.

In order to improve responsiveness when media servers 110 enter low-power modes, the system 100 may provide a low power proxy 132 that acts on behalf of sleeping media servers 110 and other devices on the UPnP network 104. The low power proxy 132 can enable elements of the UPnP network 104 to interact as if the sleeping device were still active. The low power proxy 132 can respond to search requests that are intended for deep sleep/offline devices. The low power proxy 132 may be a standalone device, or be integrated with other network entities. For example, the illustrated content gateway 128 may contain a low power proxy module 132A that performs some or all of the functions of a standalone low power proxy 132. The low power proxy module 132A may be included in other network devices, including the IGD 108, selected media servers 110, user device 118, etc.

In one configuration, the low power proxy 132 can wake up sleeping devices using a link layer wake-up mechanism such as wake-on-LAN in response to network request. The low power proxy 132 can provide other functions to increase power saving capabilities of UPnP devices. For example, when a device is in transparent mode, the proxy 132 can send SSDP announcements notify message on behalf of media servers 110 (or other devices). The SSDP messages are normally sent by the media servers 110 to advertise services. In addition, the proxy 132 (either alone or in conjunction with an aggregated CDS 130) may be enabled to respond to device discovery multicast requests (called M-SEARCH directives) targeted to the media servers 110. The M-SEARCH messages are used to find UPnP-capable devices of interest on the network 104, and the targeted devices (e.g., media servers 110) typically respond directly to the requester with information about how to use the targeted device. However, the low power proxy 132 may be enabled to provide these responses on behalf of the media servers 110, thus reducing the power requirements of the media servers 110.

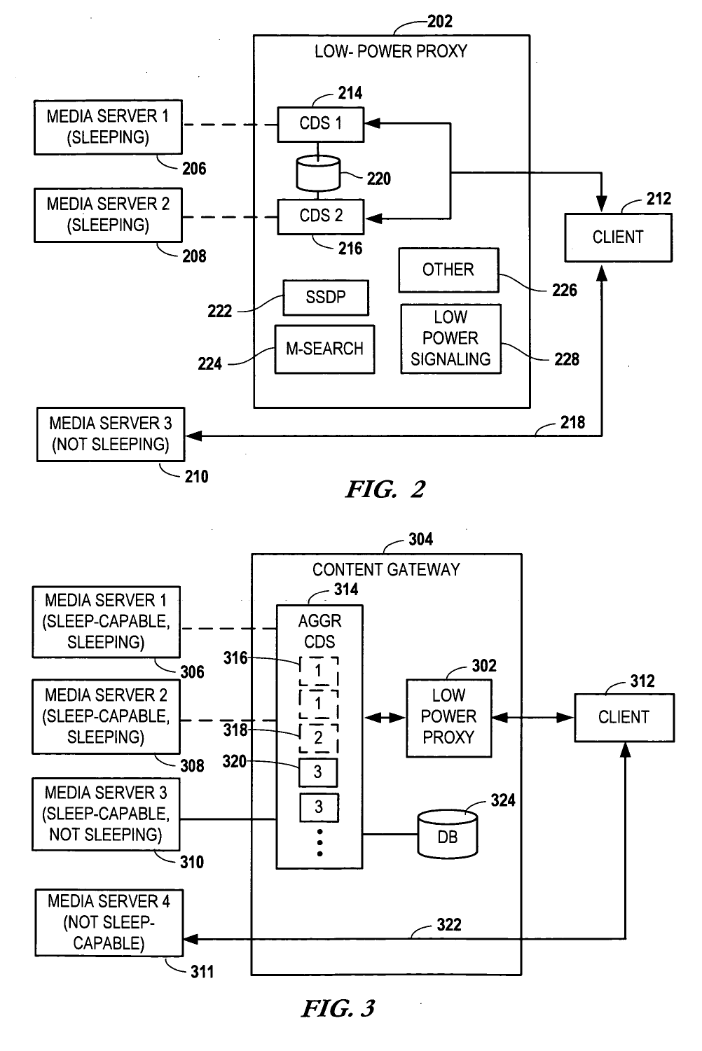

In reference now to FIG. 2, an example is shown of a low power proxy 202 according to embodiments of the present invention. The low power proxy 202 is a device that provides directory services on behalf of one or more media servers. Here, three media servers 206, 208, and 210 are shown. A client 212 is configured to access content listings of the media servers 206, 208, 210 via the low power proxy 202. For example, the client 212 may access the CDSs of respective UPnP media servers 206, 208, 210 via the low power proxy 202 if the media servers 206, 208, 210 are in a sleep state.

Generally, sleep capable media servers 206, 208, 210 outsource part of CDS functions to the lowpower proxy 202 while the servers 206, 208, 210 are in a sleep state. In the illustrated example, the low power proxy 202 acts as an agent for sleeping media servers 206, 208. The media servers 206, 208 may be in any sleep state defined by the system architecture, including UPnP low power states described hereinabove. The proxy 202 responds to content search queries received from the client 212 on behalf of the sleeping servers 206, 208. For each low power media server 206, 208 that is registered with low power proxy 202, the media server 206, 208 outsources its part of CDS functions to the proxy 202 when the server 206, 208 is in any deep sleep states.

The low power proxy 202 can cache the detailed information about individual content objects that are contained in CDSs of the sleeping media servers 206, 208. In the illustrated arrangement, the caching is represented by mirrored, virtual CDSs 214, 216 that correspond to respective sleeping media servers 206, 208. The low power proxy 202 may also modify the service control protocol definition URL (SCPDURL) and control URL (ControlURL) inside device description documents (DDD) that are provided on behalf of sleeping servers 206, 208. The low power proxy 202 caches the DDD and service control protocol documents (SCPDs), and may change the SCPDURL and ControlURL so that the SCPDURL and ControlURL entries point to the low power proxy 202 instead of the media servers 206, 208. In this way, when a control point 212 receives the SSDP announcements from the proxy 202 and tries to fetch those documents, the valid URLs are received by the control point 212.

After each virtual CDS 214, 216 is setup for use by the low power proxy 202, the proxy 202 can act on behalf of sleeping media server by responding to the queries from a control point (e.g., the client 212) or from other UPnP entities. The media server 210 that is not sleeping may have all content and CDS requests sent directly to the server 210, as represented by path 218. If the low power proxy 202 receives actions that require direct action by one of the sleeping media servers 206, 208, the proxy 202 can wake up the affected media server 206, 208 and redirect the action to the server 206, 208. Actions that may require direct action by a media server 206, 208, 210 include creating new content objects, playing content objects, transferring content objects, etc.

The virtual CDSs 214, 216 maintained by the low power proxy 202 on behalf of sleeping media servers 206, 208 may be kept as logically separate entities (as shown) or be combined into a single logical CDS. If the CDSs 214, 216 are combined into a single directory service, the low power proxy 202 may perform additional operations on the directory entries, such as merging duplicate entries. If the low power proxy 202 detects that one of the media servers 206, 208 has awakened, the proxy 202 may stop sending announcements, and control point 212 will thereafter send queries to directly to media servers 206, 208. Alternatively, the content gateway 204 (via the low power proxy 202 or other program) may continue to maintain the mirrored CDS 214, 216. If the CDSs 214, 216 are maintained while the servers 206, 208 are active, the media servers 206 and content gateway 204 will require some means of synchronizing the directory metadata so that the mirrored CDSs 214, 216 remain current.

Generally, the entries of the CDSs 214, 216 may be stored in some sort of volatile or non-volatile memory, such as data store 220. The data store 220 may include a filesystem and/or database, and will generally be used to store other state data for the low power proxy 202. For example, the low power proxy 202 may be equipped with proxy modules 222, 224, 226 to handle SSDP, M-SEARCH, or other network transactions. Each of the proxy modules 222, 224, 226 may maintain relevant state data in the data store 220 on behalf of media servers 206, 208, 210.

The low power proxy 202 may contain a low power signaling module 228 that detects low power states of the media servers 206, 208, 210 and other network elements (e.g., the client 212). A low-power signaling module 228 may be used to initiate synchronization between a media server (e.g., server 206) and a mirrored CDS (e.g., CDS 214) just before the server enters a sleep state. In this way, the low power proxy 202 can ensure the mirrored CDS 214 is up to date. The low power signaling module 228 may also be configured to signal to a sleeping media server 206, 208, 210 to wake up in response to a system event.

An alternate arrangement of a low power proxy 302 according to an embodiment of the present invention is shown in FIG. 3. In this example, the low power proxy 302 may is integrated with (or otherwise coordinates with) a content gateway 304 which provides content services for sleep capable media servers 306, 308, and 310. The content gateway 304 may also communicate with a non-sleep capable media server 311.

In the illustrated content gateway 304, a single aggregated CDS 314 is used to respond to content queries from a client 312. The aggregated CDS 314 contains the copies of CDS objects (e.g., metadata) in sleep capable media servers 306, 308, 310. The aggregated CDS 314 may be continually maintained for all sleep-capable media servers 306, 308, and 310 regardless of whether the servers are currently sleeping or active.

In the approach illustrated in FIG. 3, the aggregated CDS 314 of the content gateway 304 is tied together with UPnP low power management provided by the low power proxy 302. The content gateway 304 is able to distinguish between sleep-capable media servers 306, 308, 310 and non-sleep capable media servers 311. The content gateway 304 caches the CDS contents of sleeping media servers 306, 308 in the aggregated CDS 314. Example metadata of the sleeping servers 306, 308 is here represented respective by CDS entries 316, 318. The aggregated CDS 314 may also contain metadata of the non-sleeping servers (e.g., server 310), here represented by CDS entry 320.

The aggregated CDS 314 may be configured to only support limited actions, such as search and browse requests targeted for the media servers 306, 308, 310. Typically, no content files are cached in the content gateway 302. To keep the size of the aggregated CDS 314 manageable, the content gateway may be configured to only cache CDS content of CDS from sleep capable media servers 306, 308, 310. When the client 312 searches content via the content gateway 302, the content gateway 302 may forward the query to non-capable media servers 311, as represented by path 322. At the same time, the content gateway 302 can search its aggregated CDS 314 and return any results on behalf of the sleep-capable servers 306, 308, 310.

The content gateway 304 may be configured to build a searchable database 324 using cached the CDS data obtained from sleep-capable media servers. A search tool using structured query language (SQL) or similar tools may be used to help manage this database 324. The content gateway 304 may implement power aware control point functions on its own or (as illustrated) co-locate with the low power proxy 302. This allows the content gateway 304 to determine whether the media server has low power service. If the content gateway 304 detects sleep capable media servers 306, 308, 310, it will build the aggregated CDS 314 and cache database 324 of content objects that are contained in the media servers 306, 308, 310.

The low power proxy 302 illustrated in FIG. 3 may include features shown in the low power proxy 202 of FIG. 2. For example, the low power proxy 302 (or content gateway 304) may also include functions that are related to proxies for SSDP 222, M-SEARCH 224, other 226 and a low-power signaling module 228. One difference between the low power proxies 202, 302 is that the first the low power proxy 202 provides an independent CDS 214, 216 on behalf of each sleeping media server 206, 208. In the low power proxy 302, a copy of content hierarchy of media servers 306, 308, 310 is contained in the aggregated CDS 314, and the content gateway 304 may search for content metadata directly from a database 324.

There are a number of ways the content gateway 304 can build the content database 324. In one configuration, a search/ browse action is used to retrieve the detailed information (e.g., metadata) about the individual content objects. However, the full hierarchy is typically never returned in one call, because this may flood the resources available to the control point (memory, network bandwidth, etc.). The low power proxy 302 and/or content gateway 304 may implement short scripts or other programmatic procedures to make sure that the full hierarchy information can be retrieved in incremental way. In another implementation, the content gateway 304, low power proxy 302, and/or media servers 306, 308, 310 may be enable to support an out-of-band metadata transfer in order to synchronize metadata smoothly.

It will be appreciated that the content gateway, 304 will require a process for synchronizing CDS data between the media servers and caches and/or CDSs maintained by the gateway 304. This synchronization process should be done before any affected media server goes into a deep sleep mode. The synchronization may involve polling of the media servers and/or detecting change events communicated from the media servers. The synchronization may involve examining server metadata such as file/stream identifiers (e.g., names, file sizes, modification dates), hash values calculated on objects and/or collections of objects, or any other method of synchronizing data collections known in the art.

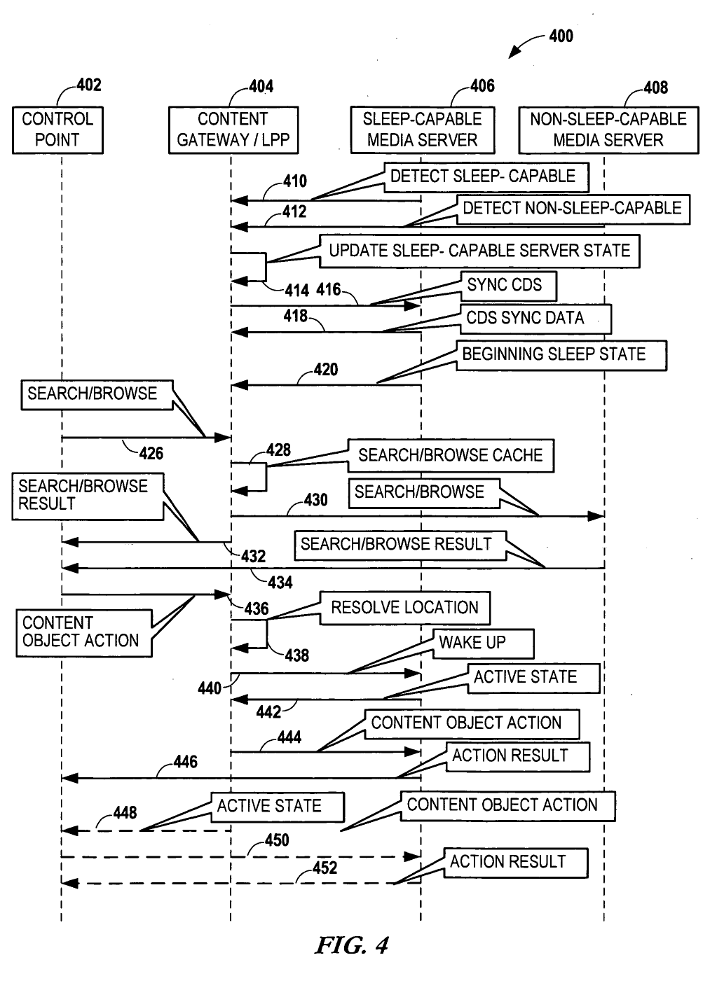

An example of synchronizing and providing content data from a low power proxy integrated with a content gateway according to embodiments of the invention is shown in the sequence diagram 400 of FIG. 4. A UPnP control point 402 is capable of communicating via a content gateway/low power proxy 404 for accessing content from either of a sleep-capable media server 406 and a non-sleep-capable server 408. The functions of the content gateway/low power proxy 404 may be contained in a single device, or may be distributed through any number of devices on a UPnP network. For purposes of description, the content gateway/low power proxy 404 may be described in relation to FIG. 4 as either a content gateway or low power proxy where appropriate.

The content gateway/low power proxy 404 includes the ability to detect (410, 412) the low power capabilities of the media servers 406, 408. These communications are used to update (414) a local state variable. Because the content gateway/low power proxy 404 determines that the first server 406 is sleep-capable, the proxy initiates synchronization (416, 418) of the CDS entries between the media server 406 and content gateway/low power proxy 404. If this is the first time that the content gateway 404 has detected the media server 406, the synchronization (416, 418) may involve the entire download of CDS entries (or portions thereof) from the media server 406. If the content gateway 404 has previously cached CDS data for the media server 406, the synchronization (416, 418) may involve analyzing various data associated with the CDS metadata to find differences from the cached data.

One example of analyzing server data to effect partial synchronization involves the use of SystemUpdateID and ContainerUpdateID state variables that may be provided in response to CDS queries. These IDs can identify whether anything in the CDS or a container object, respectively, has changed. The content gateway/low power proxy 404 can compare previously cached values of SystemUpdateID and ContainerUpdateID from the CDS of the media server 406. Differences between the cache and media server CDS can be detected by recursively navigating through all containers on the media server's CDS that have a different ContainerUpdateID than the ID that is cached on the content gateway 404. Metadata from changed containers can be re-downloaded to the content gateway 404.

After the sleep-capable media server 406 and the content gateway 404 have synchronized (416, 418) the CDSs, the content gateway 404 will continue to monitor the UPnP traffic to determine whether the media server content changes. This information may come from events initiated at the media server 406, or may come from elsewhere. For example, a command originating from the control point 402 that instructs the media server 406 to delete an object can be detectedby the content gateway 404 and used to delete the CDS entry cached on the content gateway 404 that is associated with the deleted object.

After the sleep-capable media server 406 and the content gateway/low power proxy 404 have synchronized (416, 418), the low power proxy 404 will listen for SSDP notification 420 that indicates the media server 406 will soon enter a sleep state. Thereafter, when the content gateway 404 receives a content query (426), the content gateway 404 knows to perform the query locally (428) on behalf of the sleeping media server 406. The content gateway 404 also forwards (430) the query to the non-sleep-capable media server 430.

Both the content gateway/low power proxy 404 and non-sleep-capable media server 430 will return results (432, 434) from their respective databases. The results returned from the content gateway 404 will be at least indicate the content available at the sleeping media server 406, as well as any other media servers (not shown) that the low power proxy 404 may be acting on behalf of.

If the control point 402 communicates (436) that it wants to perform an action on an object, the content gateway/low power proxy 404 will receive the action and resolve (438) the address of the target media server. As this action request (436) is targeted for the sleeping media server 406, the low power proxy 404 will signal (440) the media server 406 to wake up. When the media server 406 has acknowledged (442) that it is active, the action request is forwarded (444) to the media server 404, which fulfills the action and returns (446) the result to the control point 402. In an alternate implementation, the proxy 404 may respond to the action by indicating (448) to the control point 402 that the media server 406 is in the process of waking up. After the control point 402 receives the indication (448), the control point 402 sends the action again (450) directly to the media server 406, and then receives (452) the result.

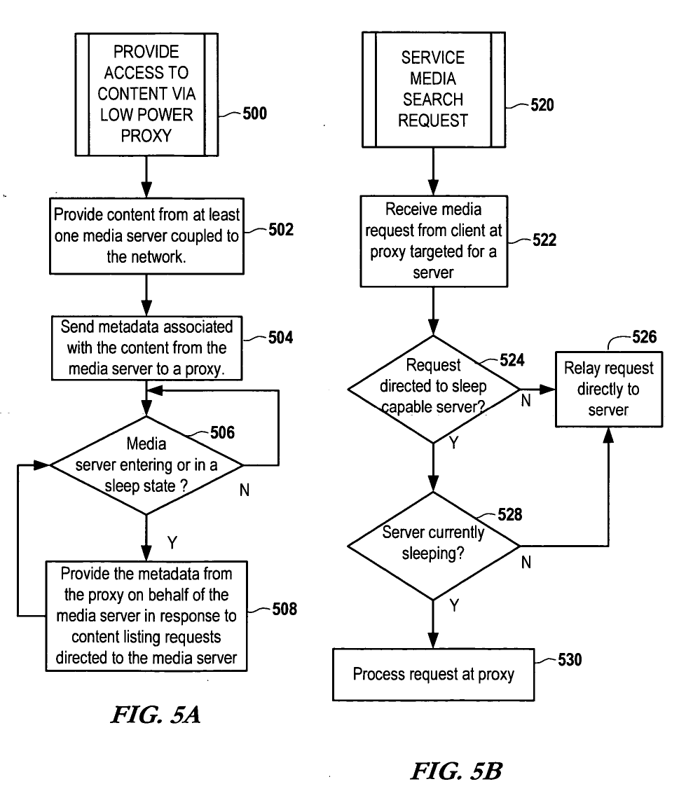

A procedure 500 for providing access to content via a low power proxy according to embodiments of the present invention is shown in FIG. 5A. The procedure involves providing (502) content from at least one media server coupled to the network. Metadata associated with the content is sent (504) from the media server to a proxy. If the media server enters a sleep state (506), the metadata is provided (508) from the proxy on behalf of the media server in response to content listing requests directed to the media server.

In reference now to FIG. 5B, a flowchart illustrates a more particular procedure 520 for providing access to content via a low power proxy according to embodiments of the invention. The procedure 520 is generally applicable to a content gateway 304 that includes a low power proxy 302 such as illustrated in FIG. 3. The proxy receives (522) a request target for a server. This request may be, for example, a browse or search request directed to a media server CDS. The proxy determines (524) whether the request is directed to a sleep capable server. If not, the request is relayed (526) directly to the target server. Next the proxy determines (528) whether the target server is currently sleeping. In some configurations, the request is relayed (526) to the target server if it is not sleeping. If the target server is sleeping (or if the proxy is configured to handle requests for non-sleeping servers), the request is processed (530) at the proxy.

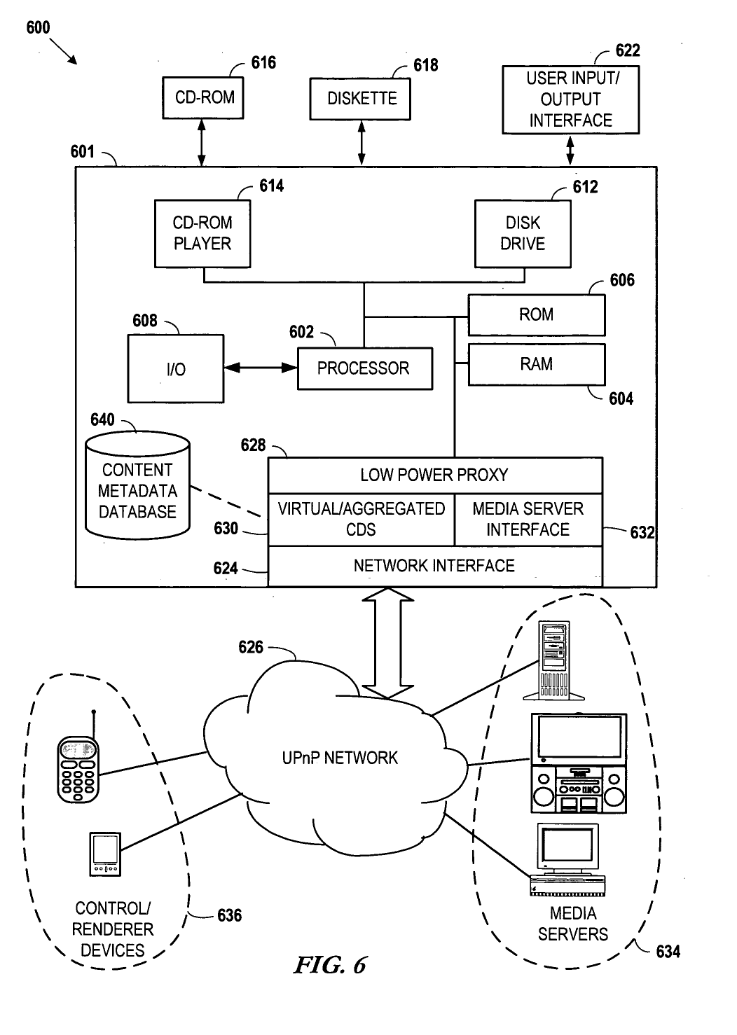

Any combination of computing hardware used to implement the content gateways and low power proxies as herein. FIG. 6 shows an example computing structure 600 suitable for providing content gateway and low power proxy functionality according to embodiments of the present invention. The computing structure 600 includes a computing arrangement 601. The computing arrangement 601 may include custom or general-purpose electronic components. The computing arrangement 601 includes a central processor (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 carries out a variety of functions as is known in the art, as dictated by software and/or firmware instructions.

The computing arrangement 601 may include one or more data storage devices, including hard and floppy disk drives 612, CD-ROM drives 614, and other hardware capable of reading and/or storing information such as DVD, etc. In one embodiment, software for carrying out the operations in accordance with the present invention may be stored and distributed on a CD-ROM 616, diskette 618 or other form of media capable of portably storing information. These storage media may be inserted into, and read by, devices such as the CD-ROM drive 614, the disk drive 612, etc. The software may also be transmitted to computing arrangement 601via data signals, such as being downloaded electronically via a network, such as the Internet. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The computing arrangement 601 may be coupled to other computing devices via networks. In particular, the computing arrangement includes a network interface 624 for interacting with a UPnP network 626. The network interface 624 may include a combination of hardware and software components, including media access circuitry, drivers, programs, and protocol modules. The network interface 624 allows the software of the computing arrangement 601 to communicate with elements of the UPnP network 626 and any other networks accessible by the interface 624.

The computing arrangement 601 includes processor executable instructions for carrying out tasks of the computing arrangement 601. These instructions include a low power proxy 628, a virtual/aggregated CDS module 630, and a media server interface 632. The low power proxy 628 performs content directory services on behalf of media servers 634 that are in a power conservation state. For example, the low power proxy 628 may exchange data with the media servers 634 to determine sleep capabilities, detect sleep states, and cause the media servers 634 to change the current sleep state. The low power proxy 628 may also coordinate with the virtual/aggregated CDS 632 to cache directory data for media servers 634 either before, during, or after any power state changes occur.

The virtual/aggregated CDS module 632 builds, maintains, and distributes content metadata to control/renderer devices 636. The virtual/aggregated CDS 632 may emulate separate “virtual” CDS interfaces for each sleep-capable media servers 634, or may aggregate all CDS metadata for media servers 634 into a single content view for the control/render devices 636. This aggregated data may be contained within a content metadata database 640. The database 640 may be capable of advanced queries using such tools as SQL queries, search engine indexing/search, regular expression searching, etc. The virtual/aggregated CDS module 630 may present metadata to control/renderer devices 636 by way of a standard CDS interface and/or by implementing a customized UPnP service. For example, the virtual/aggregated CDS 632 may advertise an “aggregatedCDS” service that is substantially similar to the standard CDS service, but acts as a single connection point for all content directory services. The control/renderer devices 636 may include additional or alternate control point interfaces that are able to utilize this custom UPnP service.

The services provided by the virtual/aggregated CDS 632 may include extensions not available in the standard CDS. For example, browse and search functions may be work similar to the CDS counterparts. However, the virtual/aggregated CDS 632 may tailor results based on power states of the available media servers 634 as detected by the low power proxy 628. For example, a search for content may reveal the same content object is available on two or more of the media servers 634, and at least one server is in a sleep state and another server is in an active state. The search results in such a case may be tailored to present the metadata of the object on the active media server(s) first, and the metadata of the object on the sleeping device(s) second (or not at all). All other things being equal, the user will experience the lowest delay time in performing an action (e.g., playing or viewing) on an object that is accessed from the active server.

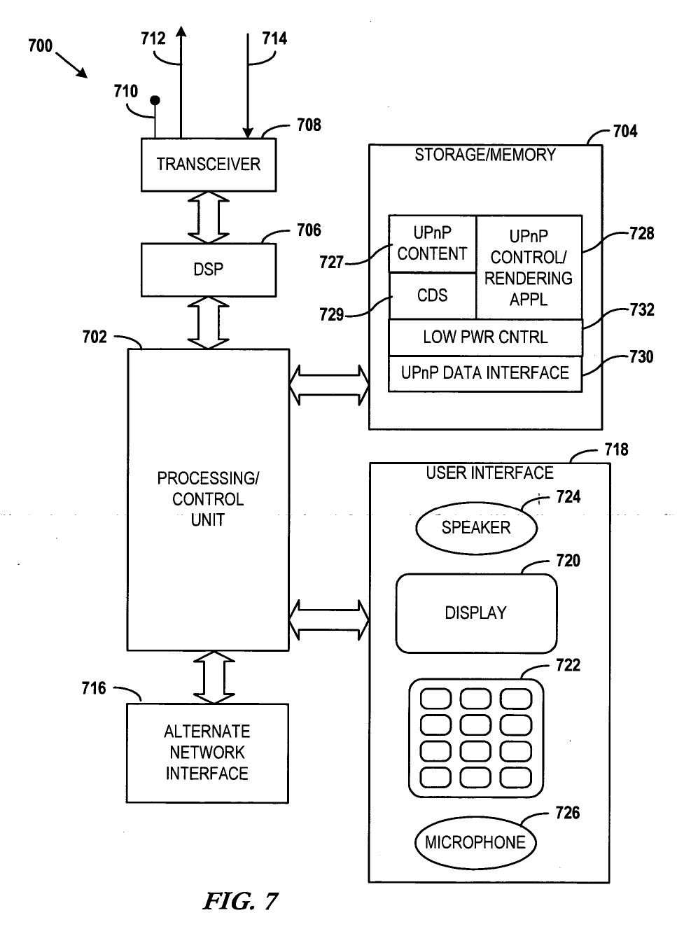

Many types of apparatuses may be able to perform roles as media servers, media renderers, and control points on a UPnP network. Mobile devices are particularly useful as control points, and may also be used as media servers and renderers. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The illustrated mobile computing arrangement 700 may suitable at least for performing any combination of roles as a media renderer, a control point, and a media server in a UPnP AV network. The mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The program storage/memory 704 may also include operating systems for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The mobile computing arrangement 700 also includes an alternate network interface 716 coupled to the processing/control unit 702. The alternate network interface 716 may include the ability to communicate on UPnP networks using any manner of data transmission medium, including wired and wireless mediums. The processor 702 is also coupled to user-interface elements 718 associated with the mobile terminal. The user-interface 718 of the mobile terminal may include, for example, a display 720 such as a liquid crystal display, a keypad 722, speaker 724, and microphone 726. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The storage/memory 704 of the mobile computing arrangement 700 may include software modules for communicating over a UPnP network. In particular, one or more applications 728 may allow the mobile computing arrangement 700 to act as a UPnP renderer and/or control point. Similarly, a UPnP content module 727 and/or CDS module 729 may allow the mobile computing arrangement 700 to act as a server on the UPnP network. Access to elements of the UPnP network for any of the UPnP functional modules 727, 728, 729 is provided via a UPnP data interface 730. The UPnP functional modules 727, 728, 729 and UPnP data interface 730 may be configured to interface with a low power proxy on the UPnP network via a low power control module 732. The low power control module 732 may include specialized functions such as receiving sleep state updates, and signaling an internally generated change in sleep or low power state.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method of providing access to content in an ad-hoc peer-to-peer network, comprising:
providing the content from at least one media server coupled to the network;
sending metadata associated with the content from the media server to a proxy;
causing the media server to enter a low-power state; and
providing the metadata from the proxy on behalf of the media server in response to content listing requests intended for the media server if the media server is in the low-power state.

2. The method of claim 1, wherein the at least one media server comprises a plurality of media servers, and wherein the method further comprises receiving the content listing requests intended for the plurality of media servers at the proxy regardless of whether the media servers are in the low power states.

3. The method of claim 2, further comprising forwarding the content listing requests to the intended media server for any media server of the plurality of media servers that are not in the low-power state.

4. The method of claim 1, wherein the at least one media server comprises a plurality of media servers, and wherein the method further comprises aggregating metadata received from the plurality of media servers into a single database.

5. The method of claim 1, wherein the at least one media server comprises a plurality of media servers, and wherein the method further comprises forming a plurality of content databases each associated with one of the media servers, wherein each content database duplicates metadata available from the associated media server.

6. The method of claim 1, wherein sending the metadata comprises sending the metadata from the media server to the proxy before the media server enters the low-power state.

7. The method of claim 6, further comprising signaling the low-power state from the media server to the proxy in response to the media server beginning to enter the low-power state.

8. The method of claim 7, further comprising synchronizing the metadata between the proxy and the media server in response to the signaling and before the media server enters the low-power state.

9. The method of claim 1, further comprising:
receiving a request for content at the proxy server in response to the metadata provided from the proxy server on behalf of the media server;
signaling to the media server to wake-up in response to the request; and
providing the requested content from the media server.

10. The method of claim 1, wherein the ad-hoc peer-to-peer network comprises a Universal Plug and Play network.

11. An apparatus comprising:
a network interface capable of communicating via an ad-hoc peer-to-peer network;
a processor coupled to the network interface; and
a memory coupled to the processor, the memory including a low power proxy having instructions that cause the processor to,
receive via the network interface metadata associated with content provided from at least one media server coupled to the network;
detect the media server entering a low-power state;
receive via the network interface content listing requests from network entities intended for the media server; and
if the media server is detected to be in the low-power state, provide the metadata to the network entities via the network interface on behalf of the media server in response to the content listing requests.

12. The apparatus of claim 11, wherein the low power proxy further causes the processor to receive the content listing requests intended for the media server if the media server is not detected to be in the low-power state.

13. The apparatus of claim 12, wherein the low power proxy further causes the processor to forward the content listing requests intended for the media server if the media server is not detected to be in the low-power state.

14. The apparatus of claim 11, wherein the at least one media server comprises a plurality of media servers, and wherein the apparatus further comprises a database coupled to the processor and wherein the memory includes instructions causing the processor to store aggregated metadata received from the plurality of media servers in the database.

15. The apparatus of claim 11, wherein the at least one media server comprises a plurality of media servers, and wherein the apparatus further comprises a plurality of content databases coupled to the processor, wherein each of the content databases is associated with one of the media servers, and wherein the memory includes instructions causing the processor to place in each content database metadata available from the associated media server.

16. The apparatus of claim 11, wherein the memory further comprises a signaling module that causes the processor to,
detect a signal via the network interface indicating the media server will enter the low-power state; and
cause the apparatus to receive the metadata from the media server in response to the signal.

17. The apparatus of claim 11, wherein the low power proxy causes the processor to receive the metadata from the media server before the media server enters the low-power state.

18. The apparatus of claim 17, further comprising a signaling module that causes the processor to detect a signal via the network interface indicating the media server will enter the low-power state.

19. The apparatus of claim 18, wherein the signaling module further causes the processor to synchronize the metadata between the apparatus and the media servers in response to the detecting the signal.

20. The apparatus of claim 11, wherein the low power proxy causes the processor to,
receive a request for content in response to metadata provided from the apparatus on behalf of the media server;
signaling to the media server to wake-up in response to the request.

21. The apparatus of claim 11, wherein the ad-hoc peer-to-peer network comprises a Universal Plug and Play network.

22. A computer-readable medium having instructions stored thereon which are executable by a data processing arrangement capable of being coupled to a network for performing steps comprising:
receiving via the network metadata associated with content provided from at least one media server coupled to the network;
detecting the media server entering a low-power state;
receiving via the network interface content listing requests from network entities intended for the media server; and
if the media server is detected to be in the low-power state, providing the metadata to the network entities via the network interface on behalf of the media server in response to the content listing requests.

23. The computer-readable medium of claim 22, wherein the steps further comprise receiving the content listing requests intended for the media server if the media server is not detected to be in the low-power state.

24. The computer-readable medium of claim 23, wherein the steps further comprise forwarding the content listing requests intended for the media server if the media server is not detected to be in the low-power state.

25. The computer-readable medium of claim 22, wherein the at least one media server comprises a plurality of media servers, and wherein the steps further comprises storing aggregated metadata received from the plurality of media servers in a single database.

26. The computer-readable medium of claim 22, wherein the at least one media server comprises a plurality of media servers and wherein the data processing arrangement comprises a plurality of content databases each associated with one of the media servers, and wherein the steps further comprise placing in each of the plurality of content databases metadata available from the associated media server.

27. The computer-readable medium of claim 22, wherein the steps further comprise:
detecting a signal via the network indicating the media server will enter the low-power state; and
causing the data processing arrangement to receive the metadata from the media server in response to the signal prior to the media server entering the low-power state.

28. The computer-readable medium of claim 22, wherein the steps further comprise receiving the metadata from the media server before the media server enters the low-power state.

29. The computer-readable medium of claim 28, wherein the steps further comprise detecting a signal via the network indicating the media server will enter the low-power state.

30. The computer-readable medium of claim 29, wherein the steps further comprise synchronizing the metadata between the data processing arrangement and the media server in response to the detecting the signal.

31. The computer-readable medium of claim 22, wherein the steps further comprise:
receiving a request for content in response to metadata provided from the data processing arrangement on behalf of the media server;
signaling to the media server to wake-up in response to the request.

32. The computer-readable medium of claim 22, wherein the ad-hoc peer-to-peer network comprises a Universal Plug and Play network.

33. A system, comprising:
at least one control point device capable of being coupled to an ad-hoc peer-to-peer network;
at least one media server capable of being coupled to the network to provide content and metadata associated with the content to the control point device;
means for providing the metadata on behalf of the media server in response to content listing requests from the control point device intended for the media server if the media server is in the low-power state.

34. The system of claim 33, further comprising:
means for receiving a request for content at the proxy server in response to the metadata provided from the proxy server on behalf of the media server;
means for signaling to the media server to wake-up in response to the request; and
means for providing the requested content from the media server.
